(19) United States
(12) Patent Application Publication
(10) Pub. No.: US 2004/0049677 A1
(43) Pub. Date: Mar. 11, 2004

(54) Authorization and security management system and method

(76) Inventors: Chung-I Lee, Tu-chen (TW); Chien-Fa Yeh, Tu-chen (TW); Zhiqiang Jiang, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/328,574

(22) Filed: Dec. 23, 2002

(30) Foreign Application Priority Data
Sep. 11, 2002 (TW) 91120667

(51) Int. Cl. H04L 9/00

(52) U.S. Cl. 713/166

(57) ABSTRACT

An authorization and security management system includes a plurality of client computers (10), an application server (12), and a database (14). Each client computer includes an interactive user interface (100) for users to send requests for operations. Each client computer is interconnected with the application server through a common network (11), and the application server is interconnected with the database through a database link (13). The application server includes an authorization device (120), a security device (121), and a verification device (122). The authorization device is for maintaining user passwords and assigning roles to users. The security device is for encrypting user passwords and decrypting encrypted passwords. The verification device is for verifying passwords input by users when the users request to log in the system, and for verifying operations requested by users. The database is for storing user IDs, user passwords, and roles assigned to users.

### FIELD OF THE INVENTION

This invention is related to systems and methods for controlling security of computer implemented systems, and especially to systems and methods for controlling system security by assigning authorities to users.

### BACKGROUND OF THE INVENTION

Security is becoming increasingly important for computer implemented systems. Traditional technologies for providing system security include access control tables and group access. An access control table controls a user's access based on predetermined access rights assigned to the user. In group access, a plurality of groups of users is defined, each group is assigned predetermined access rights, and each user is assigned to one or more of the groups. The aforesaid technology lacks flexibility in managing users and in assigning different authorities to each user. Furthermore, user IDs and passwords assigned by administrators are generally stored in original format that can be easily obtained by unauthorized persons.

U.S. Pat. No. 6,295,605 entitled Method And Apparatus For Multi-level Security Evaluation discloses a security system. The security system in large part applies the advantages of several traditional security technologies, including access control tables and group access. The security system divides users into different classes that are assigned with different authorities, and divides system resources into different classes. When a user requests to access a particular class of system resource, the system automatically selects a proper security technology to process the user's request based on predetermined rules. The security system controls security based on system resources. However, when system resources are expanded and multiplied in an organization, incorporating the extra system resources into the security system's classes is problematic.

Accordingly, it is desired to provide a system and method which overcomes the abovementioned problems and difficulties.

### SUMMARY OF THE INVENTION

A primary object of the present invention is to provide an authorization and security management system and method which assigns authorities to users based on operations.

Another object of the present invention is to provide an authorization and security management system and method which encrypts user passwords in order that the passwords can be securely transmitted through a network and securely stored in a database.

To achieve the above objects, in one aspect of the present invention, an authorization and security management system comprises a plurality of client computers, an application server, and a database. Each client computer is interconnected with the application server through a common network, and the application server is interconnected with the database through a database link. Each client computer comprises an interactive user interface for users to send requests for operations. The application server comprises an authorization device, a security device, and a verification device. The authorization device is for maintaining user passwords and assigning roles to users. The security device is for encrypting user passwords and decrypting encrypted passwords. The verification device is for verifying passwords input by users when the users request to log in the system, and for verifying whether operations requested by users are valid. The authorization device comprises a role defining unit and a user management unit. The verification device comprises a first verification unit. The role defining unit is for defining at least one role, the at least one role comprising a set of one or more operations. The user management unit is for adding, modifying or deleting user IDs and roles assigned to users. The first verification unit is for verifying users' requests for particular operations. The database is for storing user IDs, user passwords, and roles assigned to users.

In another aspect of the present invention, an authorization and security management method comprises: providing a plurality of client computers; providing an application server; and providing a database for storing user IDs, user passwords, and roles assigned to users. Each client computer comprises an interactive user interface through which users request operations. The application server comprises a role defining unit, a user management unit, and a first verification unit. The role defining unit is for defining at least one role, the at least one role comprising a set of one or more operations. The user management unit is for adding, modifying and deleting user IDs and roles assigned to users. The first verification unit is for verifying users' requests for particular operations.

In still another aspect of the present invention, another authorization and security management method comprises: (a) defining at least one role, the at least one role comprising a set of one or more operations; (b) assigning at least one role to a user, and saving the assigned at least one role to a database; and (c) determining whether an operation requested by a user is valid according to the at least one role assigned to the user.

These and other objects and features of the present invention will become more fully apparent from the following description and appended claims, or may be learned by practice of the invention as set forth hereinafter.

### BRIEF DESCRIPTION OF THE DRAWINGS

FIG. 1 shows hardware architecture of an authorization and security management system in accordance with a preferred embodiment of the present invention.

FIG. 2 shows architecture of functional modules of the system of FIG. 1.

FIG. 3 is a flow chart of setting a password using the system of FIG. 1.

FIG. 4 is a flow chart of a preferred method of implementing the system of FIG. 1.

### DETAILED DESCRIPTION OF THE PREFERRED EMBODIMENT

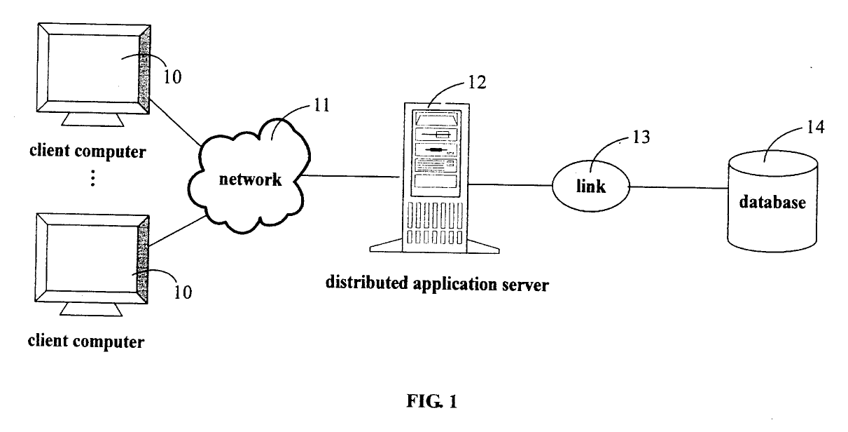

FIG. 1 shows hardware architecture of an authorization and security management system in accordance with a preferred embodiment of the present invention. The authorization and security management system comprises a plurality of client computers 10, an application server 12, and a database 14. Each client computer 10 is interconnected with the application server 12 through a common electronic communication network 11. The network 11 may for example be an Intranet, the Internet or another suitable network. The application server 12 is connected with a database 14 through a database link 13. The database link 13 may for example be Open Database Connectivity (ODBC) or Java Database Connectivity (JDBC).

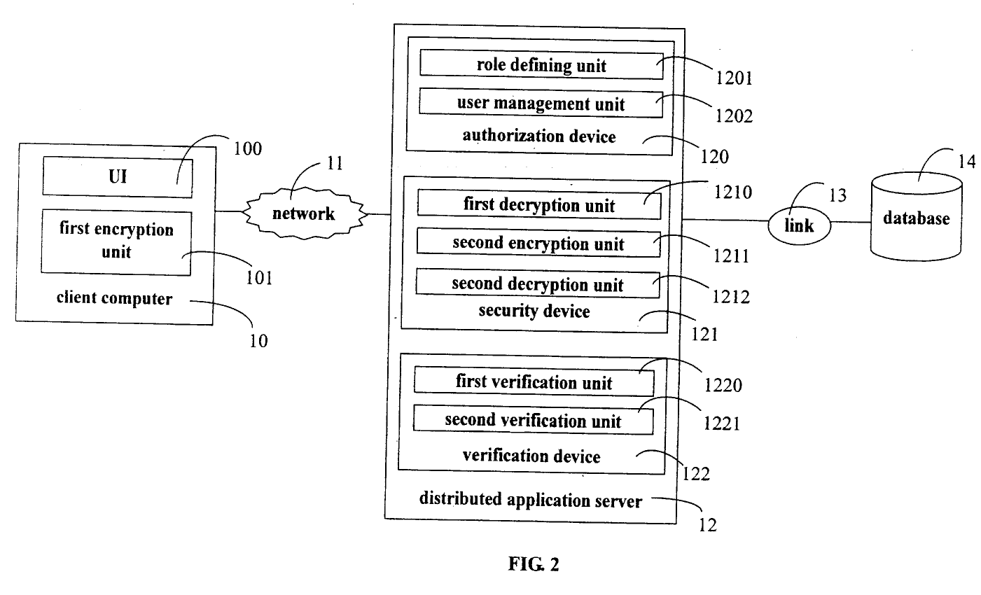

FIG. 2 shows architecture of functional modules of the authorization and security management system. Each client computer 10 comprises an interactive user interface (UI) 100, and a first encryption unit 101. The UI 101 is for accessing information stored in the database 14, and for performing certain operations such as sending out requests. The first encryption unit 101 is for encrypting users' passwords in order that the users' passwords are transmitted through the network 11 in an encrypted state.

The application server 12 comprises an authorization device 120, a security device 121, and a verification device 122. The authorization device 120 is for assigning authorities to users, and comprises a role defining unit 1201 and a user management unit 1202. All the authorization and security management system operations are predetermined by system analysts. Such operations include user management, assigning authorities, accessing certain system resources, and undertaking certain cases. The role defining unit 1201 is for defining at least one role. The at least one role is a set of at least one operation. The user management unit 1202 is used for newly adding, modifying, and deleting users and roles assigned to the users. Each user is assigned at least one role so that he has the authority to perform operations involved in all roles assigned to him.

The security device 121 comprises a first decryption unit 1210, a second encryption unit 1211, and a second decryption unit 1212. The first decryption unit 1210 is used for decrypting user passwords that have been encrypted by the first encryption unit 101. The second encryption unit 1211 is used for encrypting user passwords decrypted by the first decryption unit 1210, in order that the user passwords can be stored in the database 14 in an encrypted state. The second decryption unit 1212 is used for decrypting passwords encrypted by the second encryption unit 1211.

The verification device 122 comprises a first verification unit 1220, and a second verification unit 1221. The first verification unit 1220 is used for checking users' passwords. When a user requests to log in the authorization and security management system, he keys in his password, and the first verification unit 1220 checks the password keyed in against the user's password stored in the database 14. The second verification unit 1221 is used for verifying each user's request for a specific operation as being valid.

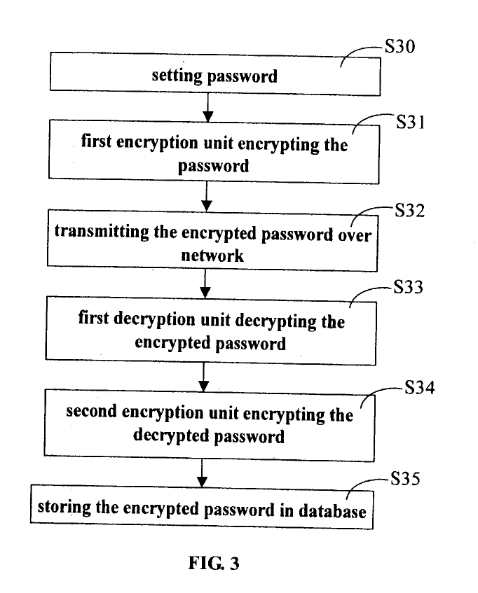

FIG. 3 is a flow chart of setting a password using the authorization and security management system. In step S30, a password is set for a user. When a new user is added to the authorization and security management system, a system administrator assigns both a user ID and a password to the user. The user can change his password through the UI 100. Once a password has been assigned by the system administrator or has been changed by the user, in step S31, the password is encrypted by the first encryption unit 101. In step S32, the encrypted password is transmitted to the application server 12 through the network 11. In step S33, the encrypted password is decrypted by the first decryption unit 1210. In step S34, the decrypted password is encrypted by the second encryption unit 1211. Finally, in step S35, the encrypted password is stored in the database 14 through the database link 13.

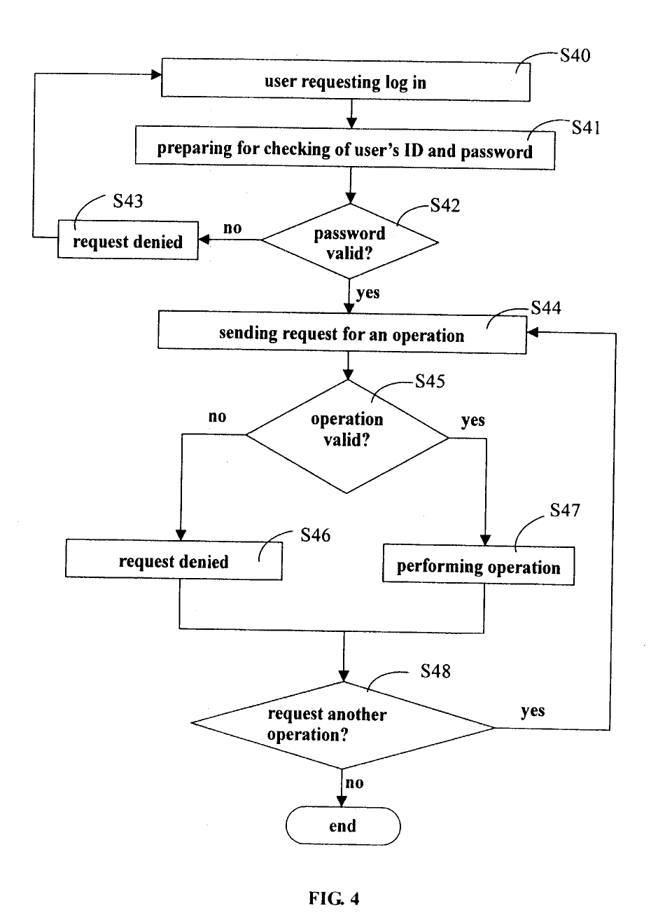

FIG. 4 is a flow chart of a preferred method of implementing the authorization and security management system. Firstly, in step S40, a user requests to log in the authorization and security management system by keying in his user ID and password through the UI 100. The password keyed in by the user is encrypted by the first encryption unit 101, and is then transmitted to the application server 12 together with the user ID. In step S41, the application server 12 prepares to check the password received from the client computer 10 against the corresponding password stored in the database 14 according to the user ID. The password received from the client computer 10 is decrypted by the first decryption unit 1210. The first verification unit 1220 searches the database 14 according to the user ID in order to obtain the stored password. The password obtained from the database 14 is decrypted by the second decryption unit 1212. In step S42, the first verification unit 1220 checks the password decrypted by the first decryption unit 1210 against the password decrypted by the second decryption unit 1212, to determine whether the password keyed in by the user is valid. If the password decrypted by the first decryption unit 1210 is the same as the password decrypted by the second decryption unit 1212, the password keyed in by the user is valid; otherwise, the password keyed in by the user is not valid. If the password is not valid, in step S43, the request to log in the authorization and security management system is denied, and the procedure returns to step S40. If the password is valid, in step S44, the user requests an operation through the UI 100, and the request is sent to the application server 12 through the network 11. In step S45, the second verification unit 1221 determines whether the operation is valid. The second verification unit 1221 searches the database 14 according to the user ID in order to obtain roles assigned to the user, and determines whether the operation is included in the roles assigned to the user. If the operation is included in the roles assigned to the user, the operation is valid; otherwise, the operation is not valid. If the operation is not valid, in step S46, the request for the operation is denied. If the operation is valid, in step S47, the operation is performed. In step S48, the user decides whether he wants to request another operation. If the user wants to request another operation, the procedure returns to step S44. If the user does not want to request another operation, the procedure is ended.

Although the present invention has been described in language specific to structural features and/or methodological steps, it is to be understood that the invention defined in the appended claims is not necessarily limited to the specific features or steps described above. Rather, the above-described specific features and steps are disclosed as preferred forms of implementing the claimed invention.

What is claimed is:

1. An authorization and security management system, comprising:
a plurality of client computers, each of the client computers providing an interactive user interface through which a user requests an operation;
an application server, comprising:
a role defining unit for defining at least one role, the at least one role comprising a set of one or more operations;
a user management unit for adding, modifying and deleting user IDs and roles assigned to users; and
a first verification unit for verifying users' requests for particular operations; and
a database for storing user IDs, user passwords and roles assigned to users;
wherein each of the client computers is interconnected with the application server through a network, and the application server is interconnected with the database through a database link.

2. The authorization and security management system as claimed in claim 1, wherein each of the client computers comprises a first encryption unit for encrypting user passwords; and
the application server further comprises:
a first decryption unit for decrypting the user passwords encrypted by the first encryption unit;
a second encryption unit for encrypting the user passwords decrypted by the first decryption unit;
a second decryption unit for decrypting the user passwords encrypted by the second encryption unit; and
a second validation apparatus for checking user passwords input by users against corresponding user passwords stored in the database to determine whether the input user passwords are valid.

3. An authorization and security management method, comprising the steps of:
providing a plurality of client computers, each of the client computers comprising an interactive user interface through which a user requests an operation;
providing an application server, comprising:
a role defining unit for defining at least one role, the at least one role comprising a set of one or more operations;
a user management unit for newly adding, modifying and deleting user IDs and roles assigned to users; and
a first verification unit for verifying users' requests for particular operations; and
providing a database for storing user IDs and user passwords and roles assigned to users;
wherein each of the client computers is interconnected with the application server through a network, and the application server is interconnected with the database through a database link.

4. The authorization and security management method as claimed in claim 3, further comprising the steps of:
setting a user password through the interactive user interface;
storing the user password in the database;
requesting login by inputting a user password; and
checking the input user password against a corresponding user password stored in the database to determine whether the input user password is valid.

5. The authorization and security management method as claimed in claim 3, further comprising the steps of:
requesting an operation through the interactive user interface;
searching the database for at least one role assigned to the user according to the user's ID;
determining whether the operation is included in the at least one role;
performing the operation if the operation is included in the at least one role; and
denying the request if the operation is not included in the at least one role.

6. The authorization and security management method as claimed in claim 3, wherein each of the client computers further comprises a first encryption unit for encrypting user passwords; and
the application server further comprises:
a first decryption unit for decrypting the user passwords encrypted by the first encryption unit;
a second encryption unit for encrypting the user passwords decrypted by the first decryption unit;
a second decryption unit for decrypting the user passwords encrypted by the second encryption unit; and
a second validation apparatus for checking user passwords input by users against corresponding user passwords stored in the database to determine whether the input user passwords are valid.

7. The authorization and security management method as claimed in claim 6, further comprising the steps of:
setting a user password through the interactive user interface;
the first encryption unit encrypting the user password and transmitting the user password to the application server through the network;
the first decryption unit decrypting the user password encrypted by the first encryption unit;
the second encryption unit encrypting the user password decrypted by the first decryption unit; and
storing the user password encrypted by the second encryption unit in the database.

8. The authorization and security management method as claimed in claim 6, further comprising the following steps:
inputting a user ID and user password to request log in;
the first encryption unit encrypting the input user password and transmitting the encrypted user password to the application server through the network;
the first decryption unit decrypting the user password encrypted by the first encryption unit;
searching the database for a corresponding user password according to the user ID;
decrypting a user password obtained from the database;
checking the user password decrypted by the first decryption unit against the user password decrypted by the second decryption unit;
validating the input user password if the user password decrypted by the first decryption unit is the same as the user password decrypted by the second decryption unit; and
denying the request if the user password decrypted by the first decryption unit is not the same as the user password decrypted by the second decryption unit.

9. The authorization and security management method as claimed in claim 6, further comprising the steps of:
sending a request for an operation through the interactive user interface;
searching the database for the at least one role assigned to the user according to the user's ID;
determining whether the operation is included in the at least one role;
performing the operation if the operation is included in the at least one role; and
denying the request if the operation is not included in the at least one role.

10. An authorization and security management method, comprising the steps of:
(a) defining at least one role, the at least one role comprising a set of one or more operations;
(b) assigning at least one role to a user, and saving the assigned at least one role to a database; and
(c) determining whether an operation requested by a user is valid according to the at least one role assigned to the user.

11. The authorization and security management method as claimed in claim 10, wherein step (c) comprises the steps of:
sending a request for an operation;
searching the database for the at least one role assigned to the user;
determining whether the requested operation is included in the at least one role assigned to the user;
performing the operation if the operation is included in the at least one role assigned to the user; and
denying the request if the operation is not included in the at least one role assigned to the user.

12. The authorization and security management method as claimed in claim 10, further comprising the steps of:
(d) setting a user password for a user;
(e) a first encryption unit encrypting the set user password, and then transmitting the encrypted user password to an application server through a network;
(f) a first decryption unit of the application server decrypting the encrypted user password;
(g) a second encryption unit encrypting the decrypted user password, and saving the encrypted password to a database; and
(h) validating a user password input by the user when the user requests log in.

13. The authorization and security management method as claimed in claim 12, wherein step (h) comprises the steps of:
(h1) inputting a user ID and a user password to request log in;
(h2) the first encryption unit encrypting the input user password, and transmitting the encrypted user password to the application server through the network;
(h3) the first decryption unit decrypting the encrypted user password;
(h4) a first verification unit searching for a corresponding user password stored in the database;
(h5) a second decryption unit of the application server decrypting a user password obtained from the database;
(h6) checking the user password decrypted by the first decryption unit against the user password decrypted by the second decryption unit;
(h7) validating the input user password if the user password decrypted by the first decryption unit is the same as the user password decrypted by the second decryption unit; and
(h8) refusing validation of the input user password if the user password decrypted by the first decryption unit is not the same as the user password decrypted by the second decryption unit.

14. An authorization and security management method for different users, comprising steps of:
providing a database;
defining different roles to operate said database at different authorization/security levels; and
assigning each of said users with at least one of said defined roles in said database; wherein
said roles were defined by a database administrator at a beginning of establishment of the database originally and seldom is revised, while each of said users is allowed to be flexibly added at least new one of said defined roles thereto or taken away said originally assigned at least one of the defined roles therefrom by the database administrator, if necessary.
